(19) United States
(12) Patent Application Publication
(10) Pub. No.: US 2006/0073000 A1
(43) Pub. Date: Apr. 6, 2006

(54) Fairway dragger

(76) Inventor: Ronald Terfry, Raynham, MA (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 11/196,126

(22) Filed: Aug. 3, 2005

Related U.S. Application Data
(60) Provisional application No. 60/598,730, filed on Aug. 4, 2004.

(51) Int. Cl. B60P 3/12

(52) U.S. Cl. 414/563

(57) ABSTRACT

A fairway dragging apparatus can remove dew and break down grass clippings from golf course fairways. Mounting saddles can be used to easily secure the apparatus to a golf course utility vehicle. The apparatus can include a pair of telescoping tube assemblies mounted transverse to the vehicle such that the tubes extend oppositely away from either side of the vehicle. Brackets for attaching weighted ropes can be mounted on the end of the innermost tube of each assembly that extends furthest from the vehicle. The ends of a weighted rope are attached to brackets on oppositely extending tubes. The rope can be much longer than the distance between the brackets, e.g., 2 to 3 times longer, such that the rope can drag on the ground when pulled by the vehicle. The tubes can be retracted to approximately the width of the vehicle.

### RELATED APPLICATIONS

This application claims priority to, and incorporates by reference, the entire disclosure of U.S. Provisional Patent Application No. 60/598,730, filed on Aug. 4, 2004.

### FIELD

The systems and methods relate to pulling a weighted, slender length of flexible material over an expanse of turf, and more particularly to a device for dragging a weighted rope over a fairway to provide a smoother playing surface.

### BACKGROUND

In order to provide improved fairways on a golf course, the fairways can be groomed by dragging a length of weighted rope over the turf surface. The weighted rope can remove dew and can break up and remove clumps of grass that may have accumulated on the fairway, e.g., from grass cuttings or player's divots.

Typically, the rope is attached to each end of a long pipe and the pipe is towed behind a small utility vehicle of the kind normally used on golf courses. The pipe is attached to the vehicle so as to be towed generally perpendicular to the line of travel of the vehicle. The rope extends between the ends of the pipe and is longer than the pipe so as to form a catenary when dragged over the turf. In some applications, the rope is attached directly to two separate utility vehicles, with the catenary being formed between the two vehicles when the rope is dragged by the vehicles as they travel over the turf.

The use of two vehicles requires two operators to perform the fairway dragging. While towing the pipe only requires a single operator, handling the long length of pipe, which can typically be on the order of 20 feet, by a single operator is awkward, at best. Also, the pipe must be removed from the vehicle when negotiating the vehicle between objects closer together than the length of the pipe, e.g., when traveling along cart paths between fairways. In addition, the pipe and rope knots frequently drag on the fairway and mark the turf.

### SUMMARY

A fairway dragging apparatus can remove dew and break down grass clippings from golf course fairways. Mounting saddles can be used to easily secure the apparatus to a golf course utility vehicle. The apparatus can include a pair of telescoping tube assemblies mounted transverse to the vehicle such that the tubes extend oppositely away from either side of the vehicle. Brackets for attaching weighted ropes can be mounted on the end of the innermost tube of each assembly that extends furthest from the vehicle. The ends of a weighted rope are attached to brackets on oppositely extending tubes. The rope can be much longer than the distance between the brackets, e.g., 2 to 3 times longer, such that the rope can drag on the ground when pulled by the vehicle. The tubes can be retracted to approximately the width of the vehicle.

In one embodiment, a towing apparatus includes a pair of oppositely extendable arms. Each arm has a plurality of nested support members and each support member has at least one stop means attached thereto, which limits the extensible movement of the support member relative to other support members of the arm. The arms are adapted for removable attachment to a vehicle. The arms are configured parallel to one another and each arm spans a width of the vehicle.

In one aspect, the towing apparatus includes a holding pin that can be inserted into aligned openings in the support members so as to maintain the relative positions of the support members. In another aspect, a handle can be secured to an inner one of the nested support members and can be used to extend the inner one of the nested support members.

In a further aspect, the towing apparatus can include a shock absorber attached to a first end of at least one support member of each arm, the first end being nearest the vehicle when the arm is fully extended, or opposite the end through which the inner tubes extend. The shock absorber can limit the extent to which the support members of the arm can be retracted. The shock absorber can include a blocking member secured within an interior portion of the support member for preventing passage of other support members nested within the support member and dampening material can be secured about the blocking member.

A pair of saddle assemblies can adapt the arms for removable attachment to the vehicle. Each of the saddle assemblies can include a first plate for removable attachment along a longitudinal rail of the vehicle, a pair of upright supports secured to the first plate and spaced apart a distance along the first plate corresponding to a width of the pair of arms. The arms can be placed between the uprights to in a parallel configuration. A second plate can span over the arms and can clamp the arms in the parallel configuration onto the saddle assembly by attaching the second plate to either the first plate or the upright supports.

The stop means can include an interiorly protruding stop fixed to the outermost one of the nested support members near the end of through which the other support members extend away from the vehicle. An exteriorly protruding stop is fixed to the innermost one of the nested support members near the end of closest to the vehicle when the arms are fully extended. The intermediate nested support members have interiorly and exteriorly protruding stops fixed near respective first and second ends.

In another embodiment, a towing apparatus for attachment to a utility vehicle can include a pair of oppositely telescoping arms, each arm having a plurality of nested tubes, a pair of saddle assemblies for attaching the arms to each of two side rails of the vehicle, the saddle assemblies configured to hold the arms parallel to one another and transverse to a longitudinal axis of the vehicle, wherein the nested tubes of the respective arms extend from opposite sides of the vehicle, and at least one bracket attachment on an inner one of the tubes of each arm for attachment of a towed device thereto, the apparatus configured to tow the device behind the vehicle when the tubes are extended. The apparatus can be configured to tow a weighted rope behind the vehicle to drag the fairway to remove dew, grass clumps and the like.

In one aspect, each saddle assembly includes a first plate for removable attachment to the side rail of the vehicle, a pair of upright supports secured to the first plate and spaced apart a distance along the first plate corresponding to a width of the pair of arms, for placement of the arms therebetween, and a second plate spanning over the arms for clamping the arms onto the saddle assembly between the upright supports when the second plate is attached to at least one of the first plate and the upright supports.

In another aspect, the apparatus can include stops for limiting the telescoping movement of tubes. The stops can include an interiorly protruding stop fixed to an outermost one of the nested tubes near a first end of through which the other tubes extend away from the vehicle, an exteriorly protruding stop fixed to an innermost one of the nested tubes near a second end that is furthest from the vehicle when the arms are fully extended, and interiorly and exteriorly protruding stops fixed near respective first and second ends of intermediate ones of the nested tubes.

A blocking member can be secured within an interior portion of a second end of at least one tube of each arm so as to prevent passage of tubes nested within the at least one tube to limit an extent to which the tubes of the arm can be retracted. Dampening material can be secured to the blocking member to absorb shock. The towing apparatus can include a holding pin for insertion into aligned openings in the nested tubes so as to maintain the relative positions of the tubes. A handle can be secured to an inner one of the tubes for use in extending the inner one of the tubes.

### BRIEF DESCRIPTION OF THE DRAWINGS

The following figures depict certain illustrative embodiments in which like reference numerals refer to like elements. These depicted embodiments are to be understood as illustrative and not as limiting in any way.

FIGS. 1A and 1B are rear and side views, respectively, of a utility vehicle with a fairway dragger extended and a rope attached thereto;

FIG. 2 is an isometric view of the fairway dragger;

FIGS. 3A and 3B are assembled and component views of a stop assembly;

FIG. 4 is a view of another stop means.

FIG. 5 is a view of telescoping tubes of the fairway dragger.

FIG. 6 is a view of a rope attachment means;

FIG. 7 is a view of a mounting saddle attached to the utility vehicle and a tube assembly attached to the mounting saddle;

FIG. 8 is a view of the mounting saddles for attaching the tube assembly to the utility vehicle;

FIG. 9 is a view of the fairway dragger mounted on a utility vehicle; and

FIGS. 10A and 10B illustrate alternative embodiments of the extending assemblies.

### DETAILED DESCRIPTION OF CERTAIN ILLUSTRATED EMBODIMENTS

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore, unless otherwise specified, features, components, modules, and/or aspects of the illustrations can be otherwise combined, separated, interchanged, and/or rearranged without departing from the disclosed systems or methods. Additionally, the shapes and sizes of components are also exemplary and unless otherwise specified, can be altered without affecting the disclosed systems or methods.

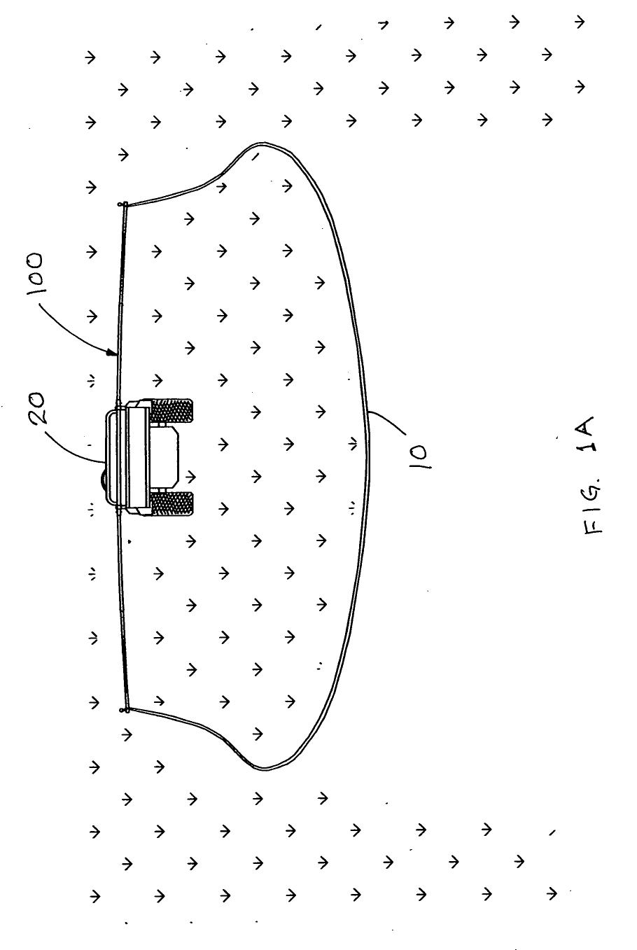

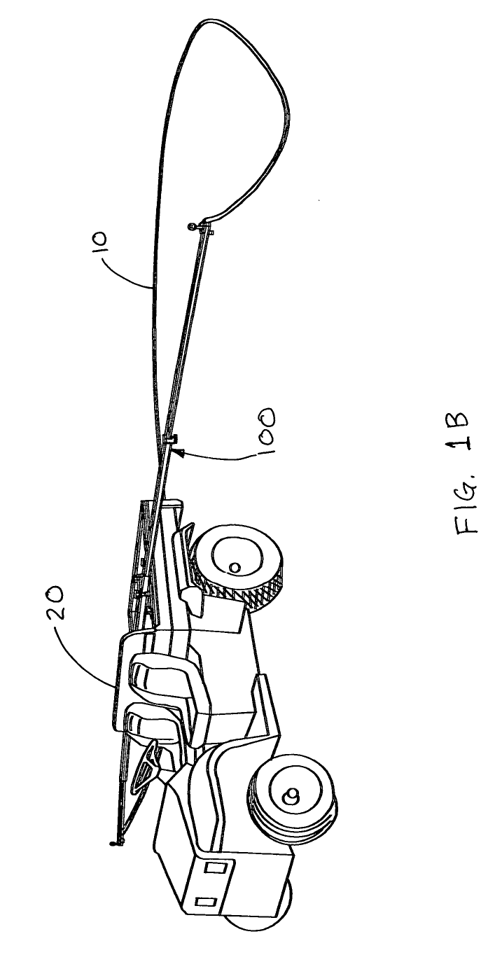

Referring to FIGS. 1A and 1B, a fairway dragging apparatus 100 is illustrated in rear and side perspective views, respectively. In the exemplary embodiment described herein, the apparatus 100 can be used to remove dew and break down grass clippings from fairways on golf courses by towing one or more lead filled ropes 10 up and down the fairways of the golf course. Other uses may become apparent to those of skill in the art, such as dragging netting to smooth out a dirt area, or towing flexible devices other than ropes 10. Thus, apparatus 100 can be a general purpose towing apparatus that can be extended in width, as further described herein, to accommodate various devices to be towed.

In the illustrated embodiment, apparatus 100 is secured to a golf course utility vehicle 20, or other movable support, for towing the ropes 10. In FIGS. 1A and 1B, the apparatus 100 is illustrated in an extended position to cover a broad area of fairway in each pass. Apparatus 100 is configured to collapse to a narrower width (not shown in FIGS. 1A and 1B) so as not to extend appreciably past the sides of the utility vehicle 20 when in a retracted position. By so collapsing, apparatus 100 can be transported on cart paths, between trees, over bridges, and other narrow places. The apparatus 100 can be mounted sufficiently high on the vehicle 20, so as not to drag on the ground or to hit the ground on uneven terrain.

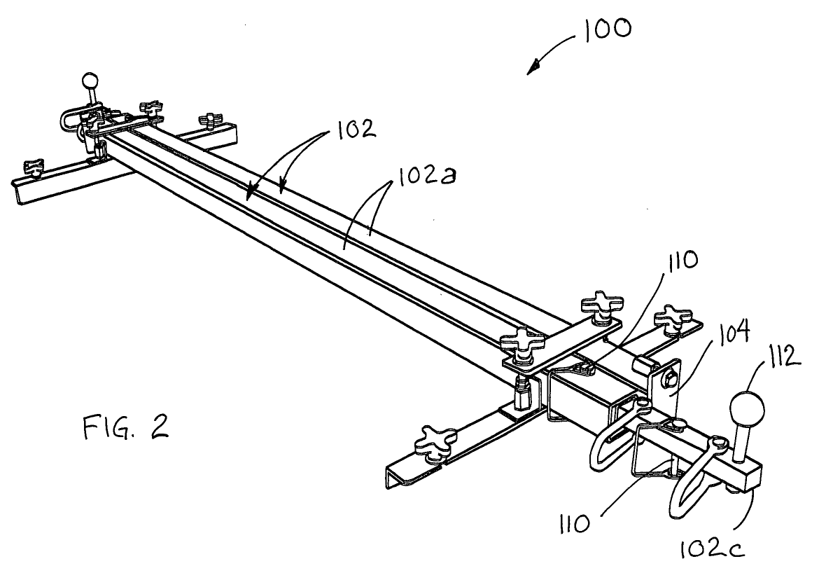

Referring to FIG. 2, one embodiment of apparatus 100 is illustrated in a perspective view and will be described herein. However, those of skill in the art can recognize that shapes, components and configurations other than those illustrated in the figures can be used to provide the features described herein.

In FIG. 2, telescoping tube assemblies 102 having telescoping tubes 102a, 102b (not shown in FIG. 2) and 102c can provide for extending the apparatus 100 to a wide width, so as to be able to cover a wide path in dragging the rope 10. For the exemplary embodiment shown in the figures, three pairs of telescoping tubes (102a-c) can be used, though other numbers and arrangements can be contemplated. For strength and ease of fabrication, the tubes 102a-c can be fabricated from standard, square, steel tubing. However other materials, including aluminum or other metals, plastic, wood, etc. can be used. Also, other cross sections of tubing, including rectangular, triangular, polygonal, oval, round, multi-lobed, or other tubing shapes and/or other shapes that can accommodate telescoping, such as channel shapes, lattices, etc. can be used.

As described above, multiple pieces of steel square tubing of varying sizes, such that one tube will fit inside the next larger tube and so on, can form a telescoping tube assembly 102. A plate or other stop means 104 is removably attached at one end of the assembly to prevent the inner tubes 102b, 102c from extending through that end and to provide access to the inner tubes 102b and 102c. A pair of assemblies 102 can be attached parallel to each other with the ends having the stop means 104 being opposite each other to allow the inner tubes 102b and 102c to be pulled out from opposite ends of the assemblies to extend the apparatus 100. The inner tubes 102b and 102c can be pushed back into the outer tube 102a to retract the apparatus.

As illustrated, the tube assemblies 102 are configured in a side-by-side relationship, though the apparatus 100 can be configured in other relationships, such as one tube assembly 102 over the other. By using two parallel tube assemblies 102, the tubes 102b and 102c can be extended to a greater distance to each side of vehicle 20 than would be possible if one outer tube 102a was configured to have tubes extending from both sides. However, configurations having one or more parallel or non-parallel tube assemblies 102 can be contemplated by those of skill in the art.

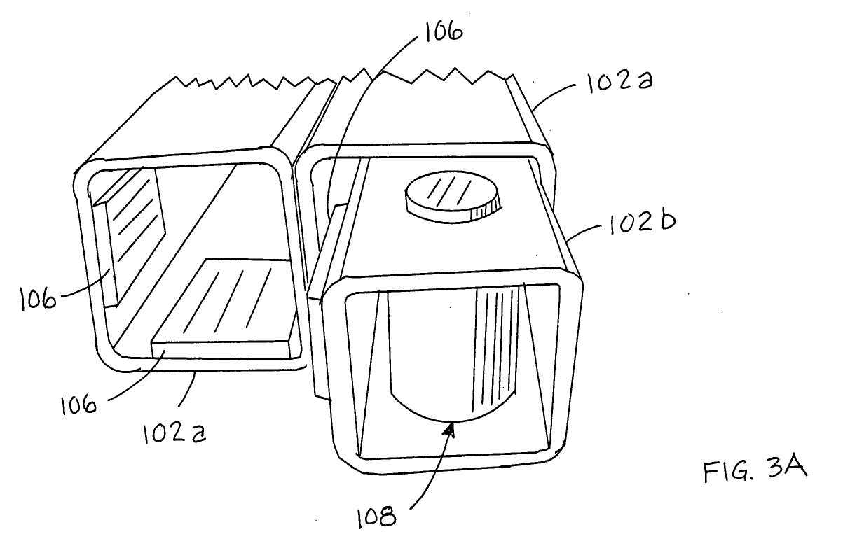

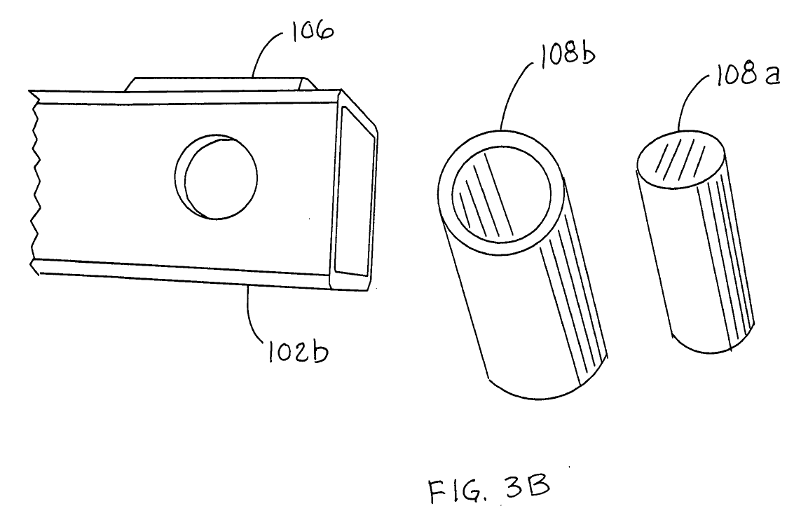

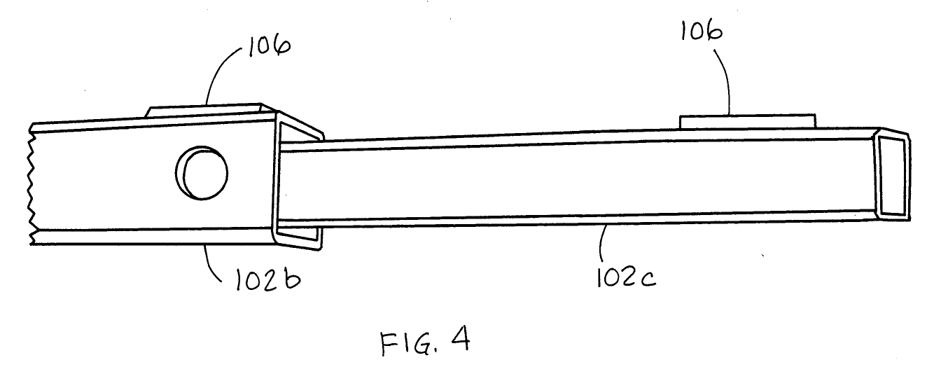

Referring to FIGS. 3A, 3B and 4, the assemblies 102 include stop means 106 to prevent the tubes 102b and 102c from being overextended. For the embodiment shown, the stops 106 include corresponding plates welded to the inner surfaces of the larger tubes and to the outer surfaces of the smaller tubes. Other types of stop means, as are known to those of skill in the art related to telescoping assemblies, can be used, such as tapering of the tubes 102a-c or spring-loaded pins and detents.

The tube assemblies 102 have stops 108 to keep them from over retracting. While stop means 104 prevents the inner tubes 102b and 102c from extending out the end of tube 102a that the stop means 104 is attached to, repeated contact of the inner tubes 102b and 102c against stop means 104 can result in damage to stop means 104 or to the ends of the inner tubes 102b and 102c. For the embodiment illustrated, the stops 108 can include a pin 108a inserted through the tube. A gasket or washer 108b fabricated of rubber or other dampening material, can surround the pin within the tube to hold the pin within the tube and to absorb the shock of an inner tube striking the pin during retraction. Other stops, including a plate or bar across the end of the tube, can be used and can be configured with springs or other dampening material for absorbing the shock.

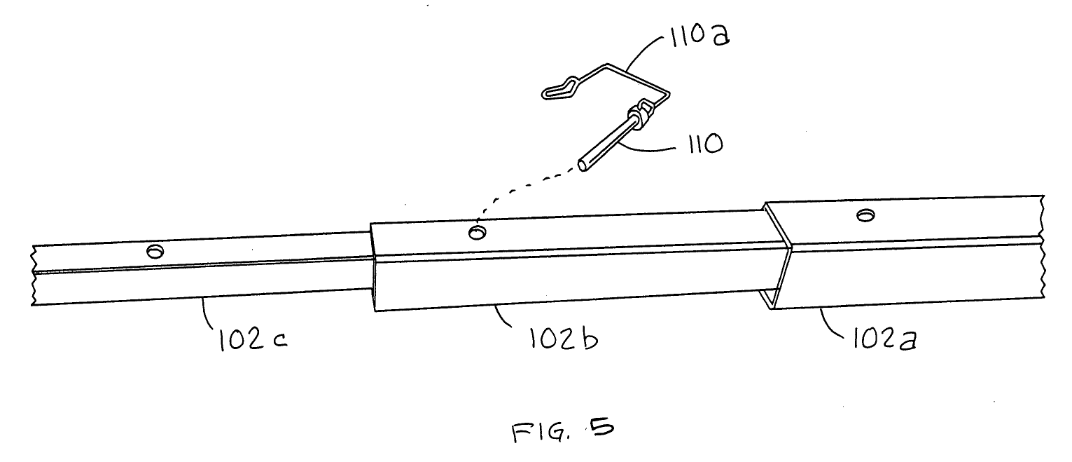

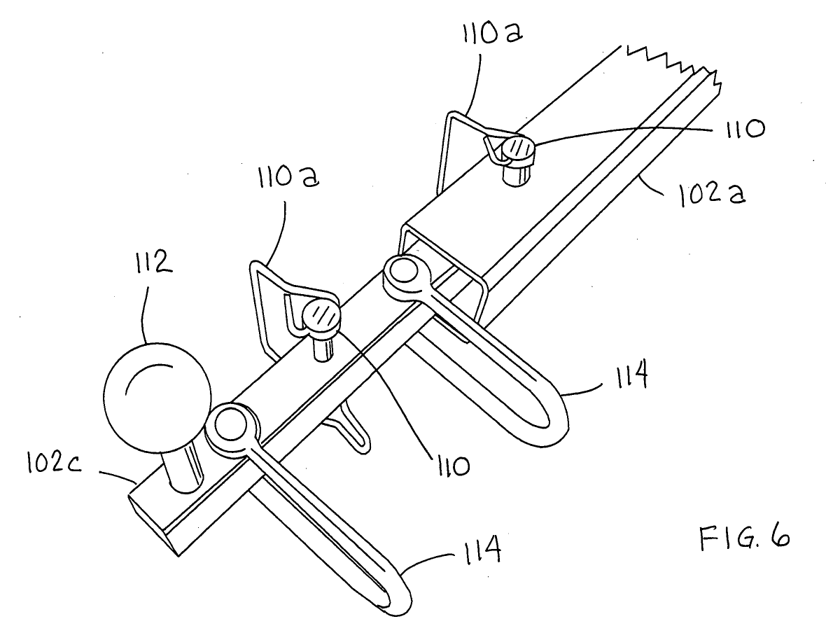

Referring also to FIGS. 5 and 6, the tubes 102a-c can have corresponding sets of holes that, when aligned, can accommodate pins 110 therethrough. In the exemplary embodiment shown, the pins 110 are circular in cross-section, though pins having other cross-sections can be used. The pins 110 can be used to hold the tubes 102a-c in the retracted position for transport of the tube assemblies 102. The inner tubes 102b and 102c can include additional sets of holes spaced along their length, such that by aligning different sets of holes and inserting a pin 110 therethrough, the inner tubes 102b and 102c can be held at various extended positions. The sets of holes can also serve to store extra pins 110, as illustrated in FIG. 2.

Each pin 110 can include a clip 110a to secure the pin 110 in one of the holes. In the illustrated embodiment, the clip 110a is pivotally attached to the pin 110 at one end and that has a loop or hook configuration at its free end that can be removably attached to the other end of the pin 110. Clip 110a is a u-shaped wire that can be easily deflected to place the loop at its free around the end of pin 110, but that has sufficient elasticity to return to its u-shape to keep the loop around the pin 110 once released. Other means of securing pins 110 can be used, including cotter pins, elastic straps, wedges and other pin securing means known in the art. Further, other means of holding the tubes 102b and 102c at various extended positions can be used, including clips, ties and other devices for securing the relative positions between two or more of the tubes 102a-c.

The inner tubes 102b and 102c can include one or more pull handles 112 provided on the extendable ends of the inner tubes 102b and 102c to aid in extending and retracting the tubes. In the illustrated embodiment, a single handle 112 is shown on inner tube 102c. For this embodiment, when the inner tube 102c is fully extended, i.e., when the tube stops 106 between the inner tube 102c and the middle tube 102b engage, pulling the handle 112 further then extends the middle tube 102b out from within outer tube 102a. In other embodiments, middle tube 102b is fitted with a handle such that middle tube 102b can be extended independently of inner tube 102c.

One or more brackets 114 can be provided on tube 102c for attaching the rope(s) 10 thereto. The use of two or more ropes 10 can provide improved fairway preparation. In one embodiment, one or more brackets can also be provided on second tube 102b for attachment of rope(s) 10 thereto. As noted herein, the apparatus 100 can be adapted for other purposes than fairway dragging. Thus, brackets 114 can be configured to suit the purpose and/or device being attached to apparatus 100.

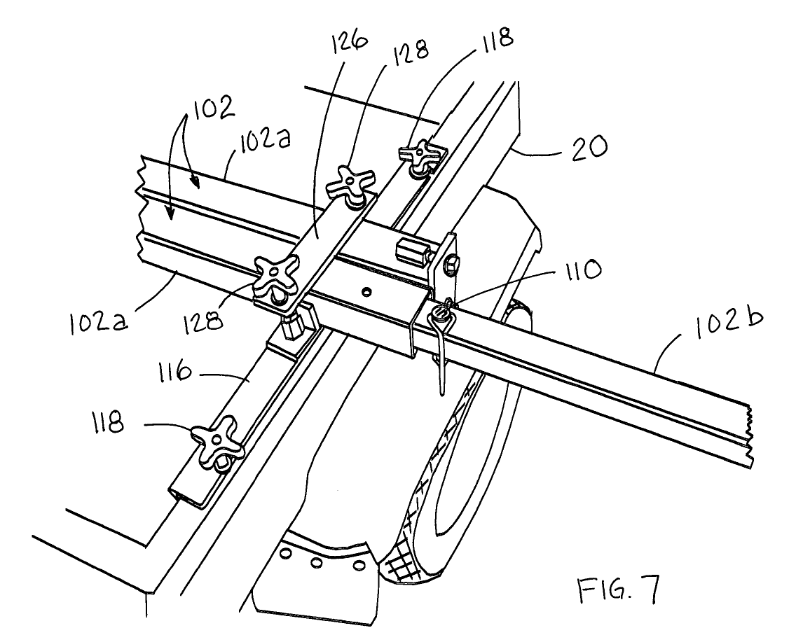

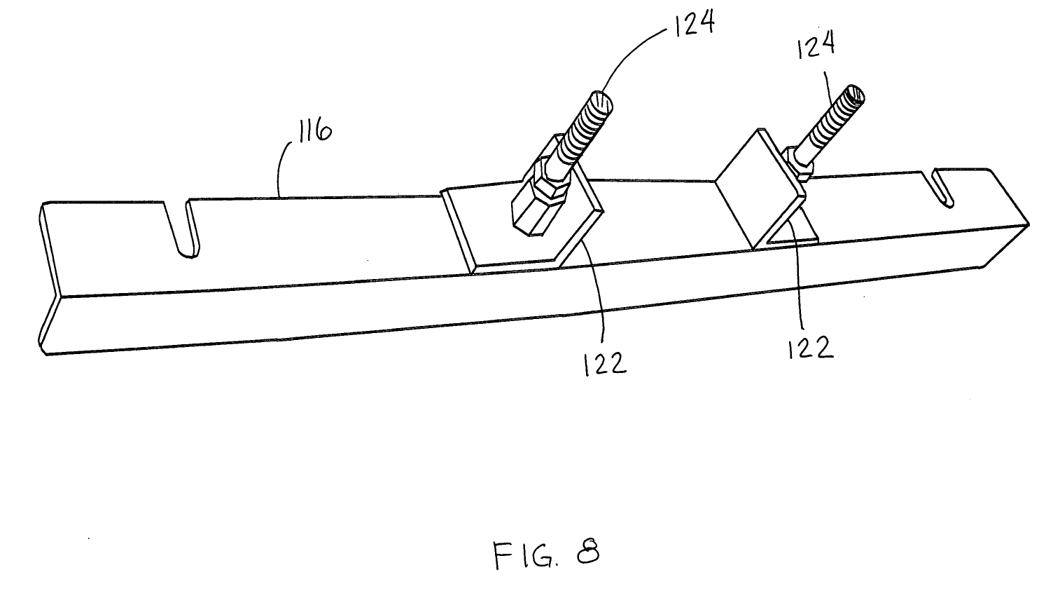

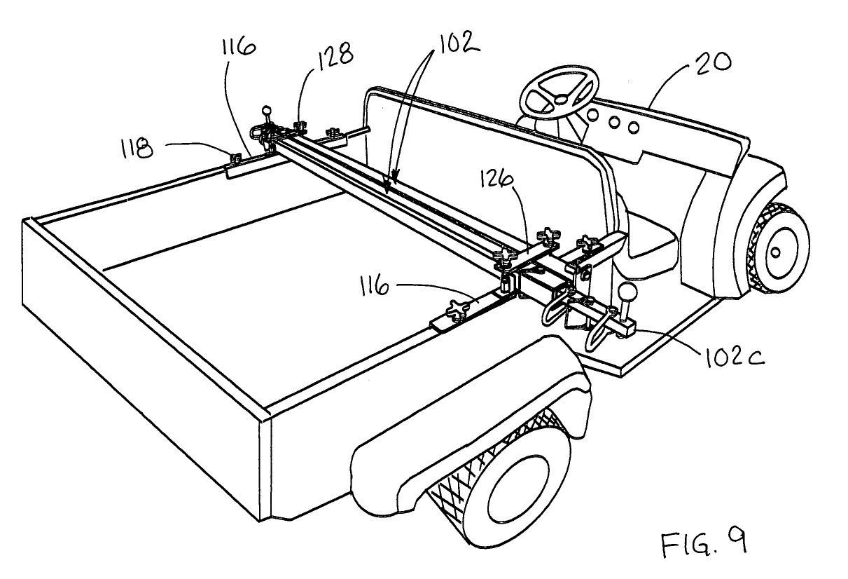

Referring also to FIGS. 7-9, the pair of telescoping tube assemblies 102 can be secured to a pair of mounting saddles 116 that in turn are secured to the vehicle 20. Golf course utility vehicles, such as vehicle 20, typically have a bed for carrying course supplies, etc. For the embodiment shown in the figures, the mounting saddles 116 can be secured to opposite side rails of the bed, e.g., by the use of threaded fasteners, 118. The saddles 116 can be fabricated from sections of steel angles, or shop fabricated to have a cross section of two plates connected at their edges to form a 90 degree angle. This shape can provide for mounting saddles 116 that can fit a wide variety of vehicles. The mounting saddles 116 can be fabricated with slots 120 for further ease of attaching the saddles to the vehicle by allowing the threaded fasteners 118 to remain attached to the vehicle when the saddles are removed. The fasteners 118 need only be loosened slightly to allow the saddles 116 to be removed by slipping the saddles 116 out from under the loosened fasteners 118. The operation is reversed to attach the saddles 116. Other types of mounting saddles or brackets can be configured to suit the particular vehicle or cart to which the tube assembly is attached.

To secure the tube assemblies 102, the mounting saddles 116 include angle brackets 122 fixed to the saddles and spaced apart to accommodate the width of the combined tube assemblies 102. Threaded studs 124 can be provided to the outside of each bracket 122. Once the tube assemblies 102 are placed between the brackets 122, plates 126, with holes therethrough to accommodate the studs 124, can be placed over the assemblies 102. Nuts 128 can be threaded onto the studs 124 protruding through the plates 126 to effectively clamp the tube assemblies 102 onto the saddles 116. The use of square or rectangular shaped tubes 102a-c can facilitate the attachment to the vehicle. For the embodiment shown, the nuts 128 and also the fasteners 118 can include knobbed extensions for ease in hand tightening. In addition, fasteners 118 can include a stud and nut assembly similar to that of stud 124 and nut 128, with the stud being secured to the bed rail of the vehicle 20.

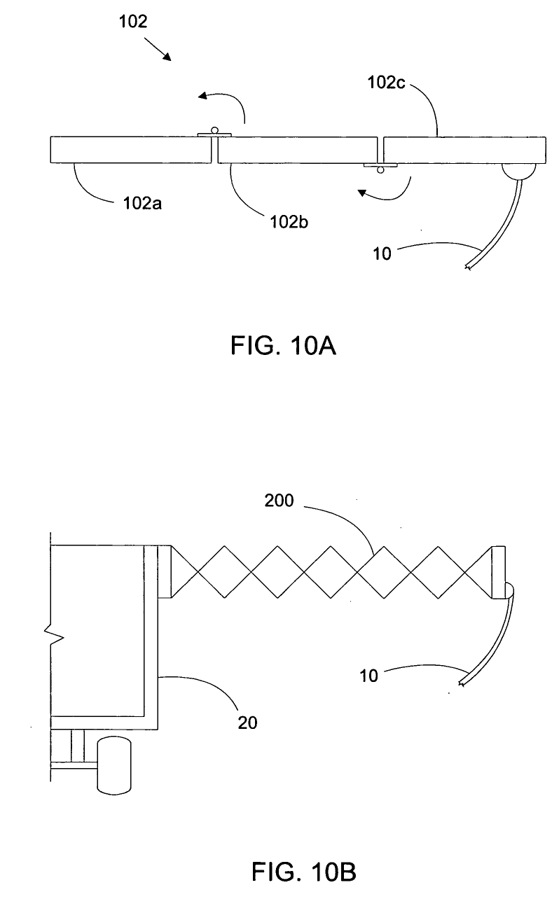

Those with ordinary skill in the art will also recognize that the elements of the figures can be combined or otherwise rearranged, and that the illustration of components and modules is merely for illustrative purposes. In one embodiment, for example, the tube assemblies 102 can be secured directly to the vehicle 20. Thus, the apparatus 100 need not include saddles 116, brackets 122 and/or clamping plates 126. Additionally, the extension of apparatus 100 can be accomplished by means other than telescoping tubes. For example, the tube assemblies 102 can unfold from a collapsed state to an extended state, as illustrated in FIG. 10A, or a scissors-type of device 200 can be used to extend the width of apparatus 100, as illustrated in FIG. 10B.

What is claimed is:

1. A towing apparatus, comprising a pair of oppositely extendable arms, each arm having a plurality of nested support members, each support member having at least one stop means attached thereto to limit extensible movement of the support member relative to other support members of the arm, the arms adapted for removable attachment to a vehicle.

2. The towing apparatus of claim 1, wherein the arms are configured parallel to one another and each arm spans a width of the vehicle.

3. The towing apparatus of claim 1, comprising at least one holding pin for insertion into aligned openings in at least two support members to maintain relative positions of the at least two support members.

4. The towing apparatus of claim 1, comprising at least one handle secured to an inner one of the nested support members, the handle for use in extending the inner one of the nested support members.

5. The towing apparatus of claim 1, comprising at least one shock absorber attached to a first end of at least one support member of each arm, the first end being nearest the vehicle when the arm is fully extended, wherein the shock absorber limits an extent to which the support members of the arm can be retracted.

6. The towing apparatus of claim 5, wherein the shock absorber comprises:
a blocking member secured within an interior portion of the at least one support member for preventing passage of support members nested within the at least one support member; and
dampening material secured to the blocking member.

7. The towing apparatus of claim 1, wherein a pair of saddle assemblies adapts the arms for removable attachment to the vehicle, each of the saddle assemblies comprising:
a first plate for removable attachment along a longitudinal rail of the vehicle;
a pair of upright supports secured to the first plate and spaced apart a distance along the first plate corresponding to a width of the pair of arms, for placement of the arms therebetween; and
a second plate spanning over the arms for clamping the arms in a parallel configuration onto the saddle assembly between the upright supports when the second plate is attached to at least one of the first plate and the upright supports.

8. The towing apparatus of claim 7, wherein the stop means comprise:
an interiorly protruding stop fixed near a first end of an outermost one of the nested support members, other support members being extended away from the vehicle through the first end;
an exteriorly protruding stop fixed near a second end of an innermost one of the nested support members, the second end being closest to the vehicle when the arms are fully extended; and
interiorly and exteriorly protruding stops fixed near respective first and second ends of intermediate ones of the nested support members.

9. The towing apparatus of claim 8, comprising:
a blocking member secured within an interior portion of the second end of at least one support member of each arm, the blocking member for preventing passage of support members nested within the at least one support member to limit an extent to which the support members of the arm can be retracted; and
dampening material secured to the blocking member.

10. The towing apparatus of claim 9, comprising at least one holding pin for insertion into aligned openings in at least two support members to maintain relative positions of the at least two support members.

11. The towing apparatus of claim 10, comprising at least one handle secured to an inner one of the nested support members, the handle for use in extending the inner one of the nested support members.

12. The towing apparatus of claim 1, wherein the stop means comprise:
an interiorly protruding stop fixed near a first end of an outermost one of the nested support members, other support members being extended away from the vehicle through the first end;
an exteriorly protruding stop fixed near a second end of an innermost one of the nested support members, the second end being furthest from the vehicle when the arms are fully extended; and
interiorly and exteriorly protruding stops fixed near respective first and second ends of intermediate ones of the nested support members.

13. A towing apparatus for attachment to a utility vehicle, comprising:
a pair of oppositely telescoping arms, each arm having a plurality of nested tubes;
a pair of saddle assemblies for attaching the arms to each of two side rails of the vehicle, the saddle assemblies configured to hold the arms parallel to one another and transverse to a longitudinal axis of the vehicle, wherein the nested tubes of the respective arms extend from opposite sides of the vehicle; and
at least one bracket attachment on an inner one of the tubes of each arm for attachment of a towed device thereto, the apparatus configured to tow the device behind the vehicle when the tubes are extended.

14. The apparatus of claim 13, wherein the towed device is a weighted rope and the apparatus is configured to drag the rope behind the vehicle.

15. The apparatus of claim 13, wherein each saddle assembly comprises:
a first plate for removable attachment to the side rail of the vehicle;
a pair of upright supports secured to the first plate and spaced apart a distance along the first plate corresponding to a width of the pair of arms, for placement of the arms therebetween; and
a second plate spanning over the arms for clamping the arms onto the saddle assembly between the upright supports when the second plate is attached to at least one of the first plate and the upright supports.

16. The apparatus of claim 13, comprising:
an interiorly protruding stop fixed near a first end of an outermost one of the nested tubes, other tubes being extended away from the vehicle through the first end;
an exteriorly protruding stop fixed near a second end of an innermost one of the nested tubes, the second end being furthest from the vehicle when the arms are fully extended; and
interiorly and exteriorly protruding stops fixed near respective first and second ends of intermediate ones of the nested tubes, the interaction of the interiorly and exteriorly protruding stops on adjacent tubes serving to limit an amount of telescoping of the tubes.

17. The towing apparatus of claim 16, comprising:
a blocking member secured within an interior portion of the second end of at least one nested tube of each arm, the blocking member for preventing passage of tubes nested within the at least one nested tube so as to limit an extent to which the support members of the arm can be retracted; and
dampening material secured to the blocking member.

18. The towing apparatus of claim 17, comprising at least one holding pin for insertion into aligned openings in at least two nested tubes to maintain relative positions of the at least two nested tubes.

19. The towing apparatus of claim 18, comprising at least one handle secured to an inner one of the nested tubes, the handle for use in extending the inner one of the nested tubes.
